(19) United States
(12) Patent Application Publication
(10) Pub. No.: US 2010/0054094 A1
(43) Pub. Date: Mar. 4, 2010

(54) Optical Disc Drive

(75) Inventor: Masaki AMANO, Yachiyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storage, Inc., Tokyo (JP)

(21) Appl. No.: 12/429,027

(22) Filed: Apr. 23, 2009

(30) Foreign Application Priority Data
Aug. 27, 2008 (JP) 2008-218448

(51) Int. Cl. G11B 7/00

(52) U.S. Cl. 369/44.25; G9B/7

(57) ABSTRACT

To obtain optimum conditions for writing data on the disc. Provided is an optical disc drive for writing/reading data on/from a loaded optical disc medium comprising: a pickup for writing/reading data on/from the optical disc medium using laser light; and a controller for controlling an operation of the optical disc drive. The controller judges whether the loaded optical disc medium is unrecorded; records a first piece of data on a test area of the optical disc medium in a case where the loaded optical disc medium is judged to be unrecorded; determines optimum output power for recording the data by reproducing the first piece of data; records a second piece of data on the test write area using the determined optimum output power; and adjusts focus balance by reproducing the second piece of data.

### CLAIM OF PRIORITY

The present application claims priority from Japanese patent application 2008-218448 filed on Aug. 27, 2008, the content of which is hereby incorporated by reference into this application.

### BACKGROUND OF THE INVENTION

This invention relates to an optical disc drive, and more particularly, to a technique for recording power to record information and adjusting focus balance.

There has been a problem of adjusting the focus balance of an optical disc drive for recording information on optical discs such as CDs, DVDs and BDs. The conventional optical disc drive records management information on the disc identification zone (DIZ) before adjusting the focus balance, and then the focus balance is adjusted on the recorded zone.

In addition, suggested is a method in which the focus balance is adjusted by reading arbitrary data recorded on the power control area (PCA) (see JP 2007-18642 A and JP 2006-216127 A).

### SUMMARY OF THE INVENTION

As described above, the conventional optical disc drive records management information on the DIZ before adjusting the focus balance. Accordingly, in a case where the management information is not properly recorded on the DIZ and the DIZ is not read. Therefore, the focus balance cannot often be properly adjusted.

Moreover, the implementation order of adjustments of the recording power and the focus balance is not significantly considered in the conventional technique. For example, the optical disc drive described in JP 2007-18642 A adjusts the recording power after the focus balance is adjusted. Also, since the optical disc drive described in JP 2006-216127 A records data for adjusting focus balance at the starting point of the PCA, the recording power is not adjusted before the focus balance.

Accordingly, there arises a problem that the data for adjusting focus balance is not written with appropriate power. More specifically, such a problem arises that a disc is damaged by writing the data with strong power or an optimum result of adjusting focus balance cannot be obtained because the data is written with the weak power.

Furthermore, as the manufacturers of the optical disc media increase, the variations of the optical disc media properties increase. In order to properly record information on the media which have a wide variety of properties, it is required to record information with appropriate write conditions for each media property.

An object of this invention is to provide an optical disc drive which is capable of writing data on a disc with optimum write conditions by setting an implementation order of the recording power adjustment and the focus balance adjustment.

A representative aspect of this invention is as follows. That is, there is provided an optical disc drive including: a pickup for writing/reading data on/from the loaded optical disc medium using laser light; and a controller for controlling an operation of the optical disc drive. The controller judges whether the loaded optical disc medium is unrecorded; records a first piece of data on a test area of the optical disc medium in a case where it is judged that the loaded optical disc medium is unrecorded, determines optimum output power for recording the data by reproducing the first piece of data; records a second piece of data on the test write area using the determined optimum output power; and adjusts focus balance by reproducing the second piece of data.

According to an embodiment of this invention, an optimum result of adjusting focus balance can be obtained and data is recorded with appropriate conditions.

### BRIEF DESCRIPTION OF THE DRAWINGS

The present invention can be appreciated by the description which follows in conjunction with the following figures, wherein:

FIG. 1 is a block diagram showing a configuration of an optical disc drive according to an embodiment of this invention;

FIG. 2 is a flowchart showing a process of controlling recording power and adjusting focus balance according to the embodiment of this invention;

FIG. 3 is an explanatory diagram showing a data format of DVD+R disc loading in the optical disc drive according to the embodiment of this invention; and

FIG. 4 is an explanatory diagram showing a data format of a Blu-ray disc loading in the optical disc drive according to the embodiment of this invention.

### DETAILED DESCRIPTION OF THE PREFERRED EMBODIMENT

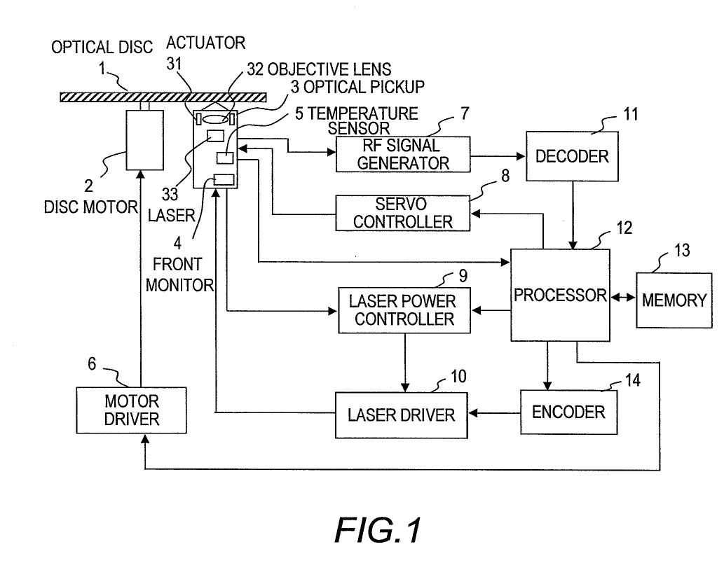

FIG. 1 is a block diagram showing a configuration of an optical disc drive according to an embodiment of this invention.

The optical disc drive according to the embodiment of this invention comprises a disc motor 2, an optical pickup 3, a front monitor 4, a temperature sensor 5, a motor driver 6, an RF signal generator 7, a servo controller 8, a laser power controller 9, a laser driver 10, a decoder 11, a processor 12, a memory 13 and an encoder 14.

The disc motor 2 is driven by the motor driver 6 and rotates an optical disc 1. The motor driver 6 controls the rotation (rotation/stop and the number of rotations) of the motor according to instructions from the processor 12.

The optical pickup 3 comprises an actuator 31, an objective lens 32, a laser 33, an optical sensor, a splitter, the front monitor 4 and the temperature sensor 5. The laser 33 is light emitter (e.g. a semiconductor laser) for emitting a predetermined intensity of laser light for recording and reproducing data. A record surface (an optical disc surface) of the optical disc 1 is irradiated with the laser light emitted from the laser 33 through the objective lens 32. The optical sensor receives the laser light reflected from the record surface of the optical disc 1 through the objective lens 32, converts the received reflected light into electrical signals and outputs the converted electrical signals. The objective lens 32 is driven and adjusted to focus the laser light on the optical disc surface by the actuator 31. The actuator 31 is driven by the servo controller 8.

The laser light emitted from the laser 33 is separated by the splitter and input to the front monitor 4. The front monitor 4 monitors the power of the laser light using the laser light separated by the splitter. The temperature sensor 5 detects temperatures of the optical pickup 3.

The RF signal generator 7 performs an analog process (amplification, demodulation and the like) on the signals sent from the optical pickup 3.

The servo controller 8 controls a focus servo, a tracking servo and a slide servo. In other words, the focus servo controls the objective lens 32 by driving the actuator 31 so that the laser light is focused on the optical disc surface. The tracking servo controls the optical pickup 3 to follow the track of the optical disc 1. The slide servo moves the optical pickup 3 to a predetermined position and controls to keep the optical pickup 3 to stay in the position.

The laser power controller 9 controls output power intensity of the laser light according to laser output power prerecorded on the optical disc 1 or laser power output determined by optimum power control (OPC). The laser driver 10 is a driver circuit for driving the laser 33. The laser driver 10 is controlled by the laser power controller 9.

The decoder 11 outputs the signals sent from the optical pickup 3 as RF signals, tracking error signals, focus error signals or the like. The encoder 14 generates data for writing on the optical disc 1.

The processor 12 controls an operation of the optical disc drive. For example, the processor 12 executes an OPC process to determine the intensity of the laser light emitted from the laser 33, and a control process for outputting the laser light used for recording. The memory 13 stores programs executed by the processor 12 and data necessary for executing the programs.

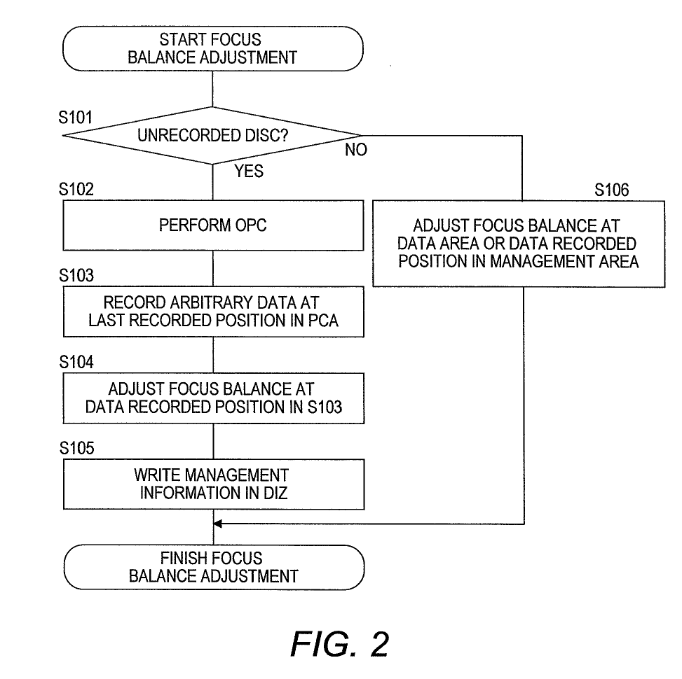

FIG. 2 is a flowchart showing a process of controlling recording power and adjusting focus balance according to the embodiment of this invention.

First, when the disc is loaded, the processor 12 instructs the servo controller 8 to move the optical pickup 3 to an initial position (such as an edge portion of the inner peripheral side). After the optical pickup 3 is moved to the initial position, the laser 33 in the optical pickup 3 is turned on. Subsequently, management information recorded on a management area (disc identification zone: DIZ) is read to determine whether the loaded disc is an unrecorded disc (a new disc) (S101). For example, since a last-recorded position is marked on the DIZ of a recorded disc, if the last-recorded position can be read from the DIZ, the disc can be determined whether it is unrecorded disc or not.

As a result, in a case where the disc is determined to be a recorded disc, the focus balance is adjusted using data already recorded on the disc (S106). The focus balance can be adjusted by reading data recorded on a data area or by reading the management information recorded on the DIZ.

The focus balance adjustment using the recorded data can be performed as described next. For example, the actuator is operated and data (or the management information) is read while changing a focus distance of the objective lens. Subsequently, an optimum focus distance of the objective lens can be determined in consideration of jitter of the read data and the like.

On the other hand, in a case where the disc is determined to be an unrecorded disc, the recording power adjustment (OPC processing) is performed by using the power calibration area (PCA) in the inner periphery (S 102). More specifically, the record surface of the optical disc 1 is irradiated with laser light of which recording power (laser output power) is changed and predetermined data (recording mark) is recorded on the optical disc 1. At this time, the recording power of the laser light can be changed from the outer periphery to the inner periphery so that the recording power is strong on the outer peripheral side and weak on the inner peripheral side. Subsequently, the optimum recording power of the laser light is determined by reading the recorded data and measuring at least one of a β value, jitter, an error rate and the like of the read data.

Subsequently, the data is recorded on the last-recorded position on the PCA using the recording power optimized in Step S102 (S103). This data is read when the focus balance is adjusted in Step S104. Accordingly, the data may be arbitrary data such as consecutive “0” data. Note that, when data for the OPC is recorded on the PCA, the focus balance is not adjusted yet. Therefore, the data can be written taking the center value of the calibration range of the focus balance.

After that, the focus balance is adjusted using the data written in Step S103 (S104). More specifically, the data written in Step S103 is read by moving the focus balance. In other words, the data written in Step S103 is read by moving the objective lens 32, thereby changing the focus distance (a spot diameter). Then, optimum reading conditions are set for the focus balance. For example, the lens position where the optimum value of the jitter (or other parameters such as modulations may be used) of the read data can be obtained is set to be the optimum focus balance of the optical disc.

Next, the management information is written on the DIZ by using the recording power set in Step S102 and the focus balance set in Step S104 (S105). The examples of the management information recorded on the DIZ are mode information of the disc, focus information and information on data writing format and the like.

In this embodiment, the focus balance is properly adjusted because the focus balance is adjusted after the OPC is performed. Namely, in a case where the OPC is performed after the focus balance is adjusted, the proper focus balance sometimes cannot be obtained because the disc is damaged due to high data writing power or written data cannot be read due to low data writing power. However, in this embodiment, the focus balance is adjusted after the OPC is performed. Consequently, the data for focus balance can be read certainly, and therefore, the focus balance can be properly adjusted.

In addition, when the management information is written on the DIZ before the focus balance is adjusted (namely, the management information is written by taking the center value of the calibration range of the focus balance), the management information cannot be properly written (e.g. a write error). Also, the focus balance is not properly adjusted because the written management information is not accurately read. Moreover, the written data cannot be reproduced because the management information is not read from the DIZ and the border of the data recorded area cannot be found (e.g. a read error). However, in this embodiment, the management information is written on the DIZ after the focus balance is adjusted, and thus, the management information is always recorded with the appropriate focus balance.

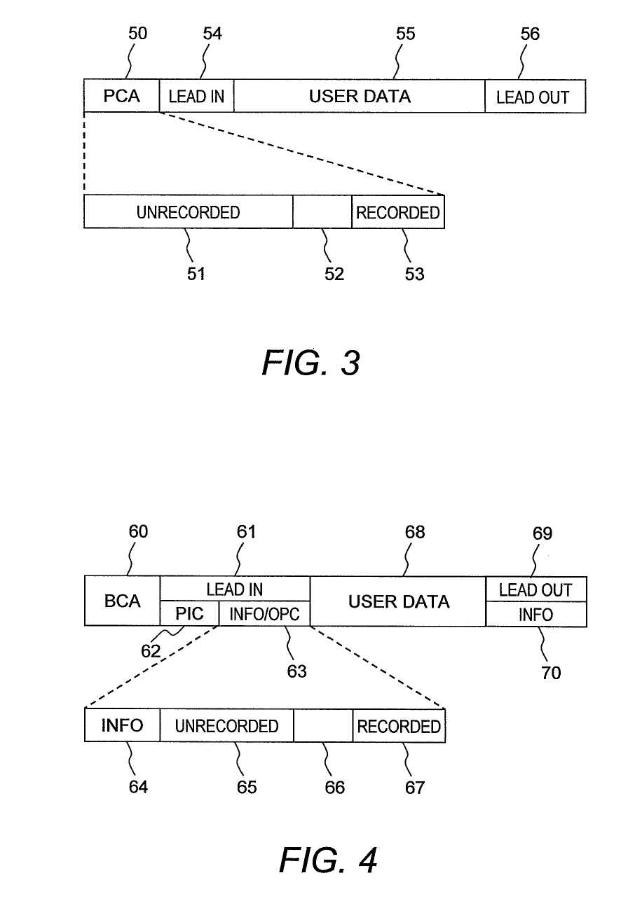

FIG. 3 is an explanatory diagram showing a structure of DVD+R disc to be loaded in the optical disc drive according to the embodiment of this invention.

On the DVD+R disc, a power calibration area (PCA) 50, a lead-in area 54, an user data area 55 and a lead-out area 56 are provided from the inner periphery.

The PCA 50 is a test area on which test data is written for determining optimum laser power for writing data. The lead-in area 54 is provided in the inner peripheral of the data record area 55. The lead-out area 56 is provided in the outer peripheral of the data record area 55.

The optical disc drive performs the OPC for writing test data using the PCA 50 before writing user data on the DVD+R disc. A part of the PCA 50 becomes a recorded area 53 by the OPC. After the OPC is performed, the optical disc drive writes data for adjusting the focus balance on an area 52 contiguous with (the inner periphery) the recorded area 53. Note that, data is not recorded in another area 51 (further inner periphery) on the PCA 50.

In this embodiment, the data for the OPC is recorded in such a manner that the recording power is lower on the outer peripheral side and higher on the inner peripheral side. Accordingly, the data can be detected at the edge of the recorded area 53 easily. On the other hand, if the data for the OPC is recorded using high recording power on the outer peripheral side and low recording power on the inner peripheral side, the it is difficult to detected data at the edge of the recorded area 53. Consequently, the phase looked loop (PLL) may be unlocked, which may cause a read error to the subsequent data for the focus balance.

Note that, the laser light is gradually changed from the low output power to the high output power in the OPC process. Accordingly, the test data is written on the outer peripheral side and the inner peripheral side of the area used for one OPC process using the low output power and the high output power, respectively. For that, in a case where the optical pickup 3 scans the disc from the outer peripheral side, the most inner periphery (namely, the end point of the recorded area 53) of the recorded area 53 on the PCA 50 can be easily detected. In addition, the both start and end points are difficult to be detected because the data is written by changing the focus distance of the objective lens 32.

Accordingly, in this embodiment, the implementation order of performing the OPC and adjusting the focus balance are set so that the both data for the focus balance and for writing for the OPC are distinctively provided by writing the data for the focus balance on the area contiguous with the recorded area 53.

This embodiment is suitable to be used, especially, for DVD+R discs. This is because even though a DVD−R disc is unused, data has been already written, however, no data has been written on an unused DVD+R disc, and thus, the need to write data for the focus balance on the DVD+R disc is higher.

Moreover, this embodiment is also usable for disc media (rewritable discs) in which data is erasable. On the rewritable discs, in a case where a write error occurs, data can be rewritten by changing writing conditions. However, the number of retry can be reduced by using the method for adjusting writing conditions in this embodiment.

The embodiment of this invention has been described using a DVD+R disc as an example. However, this invention can be applied to optical disc drives for compact discs (CDs) and blu-ray discs (BDs).

FIG. 4 is an explanatory diagram showing a structure of a blu-ray disc to be loaded in the optical disc drive according to the embodiment of this invention.

On the blu-ray disc (BD-R), a burst cutting area (BCA) 60, a lead-in area 61, an user data area 68 and a lead-out area 69 are provided from the inner periphery.

The BCA 60 stores information on an identifier of the disc, a product number and the like. The lead-in area 61 is provided in the inner peripheral of the data record area 68. The lead-out area 69 is provided in the outer peripheral of the data record area 68.

The lead-in area 61 includes a permanent information and control data (PIC) area 62 and an INFO/OPC area 63. The lead-out area 69 includes an INFO area 70.

On the PIC area 62, a data format of the disc and information (such as recording/reproducing power and recording waveform, for example) necessary for reproducing and recording on the disc are recorded. An INFO area 64 on the INFO/OPC area 63 stores management information of the data recorded on the disc. The INFO/OPC area 63 includes an area on which the test writing is performed to determine the optimum laser power for writing the data on the blu-ray disc. The INFO area 70 stores the same management information of the data recorded on the disc as the INFO/OPC area 63.

The optical disc drive writes the test data with the OPC using the area for test writing on the INFO/OPC area 63 when data is written on the blu-ray disc. After the OPC is performed, the part of the INFO/OPC area 63 becomes a recorded area 67. Subsequent to the OPC, the optical disc drive writes data for adjusting focus balance on an area contiguous with (inner periphery) the recorded area 67 on the INFO/OPC area 63. Note that, the further inner peripheral of the INFO/OPC area 63 is an unrecorded area 65.

Note that, in this embodiment, as similar to the case of the DVD described above, the laser light is gradually changed from the low output power to the high output power in the process of OPC. Accordingly, the test data is written on the outer peripheral side and the inner peripheral side of the area used for one OPC process using the low output power and the high output power, respectively. For that, in a case where the optical pickup 3 scans the disc from the outer peripheral side, the most inner periphery (namely, the end point of the recorded area 67) of the recorded area 67 on the INFO/OPC area 63 can be easily detected. In addition, the both start and end points are difficult to be detected because the data is written by changing the focus distance of the objective lens 32.

Accordingly, in this embodiment, the implementation order of performing the OPC and adjusting the focus balance are set so that the both data for the focus balance and for the test writing for OPC are distinctively provided by writing the data for the focus balance on the area contiguous with the recorded area 67.

As has been described above, according to the embodiment of this invention, after the OPC is performed, the focus balance is adjusted, so that the focus balance is properly adjusted. Moreover, since the management information is written after the focus balance is adjusted, the management information can be recorded with appropriate write conditions.

While the present invention has been described in detail and pictorially in the accompanying drawings, the present invention is not limited to such detail but covers various obvious modifications and equivalent arrangements, which fall within the purview of the appended claims.

What is claimed is:

1. An optical disc drive for writing/reading data on/from a loaded optical disc medium comprising:
a pickup for writing/reading data on/from the optical disc medium using laser light; and
a controller for controlling an operation of the optical disc drive, wherein the controller is configured to:
judge whether the loaded optical disc medium is unrecorded;
record a first piece of data on a test area of the optical disc medium in a case where it is judged that the loaded optical disc medium is unrecorded, and determine optimum output power to record the data by reproducing the first piece of data;
record a second piece of data on the test write area using the determined optimum output power; and
adjust focus balance by reproducing the second piece of data.

2. The optical disc drive according to claim 1, wherein management information is written on a management area of the optical disc medium after the focus balance is adjusted.

3. The optical disc drive according to claim 1, wherein the second piece of data is recorded from a last-recorded position of the test write area.

4. The optical disc drive according to claim 1, wherein the focus balance is adjusted by reproducing data from the recorded area of the optical disc medium in a case where it is judged that the optical disc medium is unrecorded.

5. The optical disc drive according to claim 1, wherein the optical disc medium is a DVD+R disc.
